(19) United States
(12) Patent Application Publication
(10) Pub. No.: US 2007/0081366 A1
(43) Pub. Date: Apr. 12, 2007

(54) Capacitive coupling assisted voltage switching

(76) Inventor: Ernst Stahl, Essex Junction, VT (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/247,335

(22) Filed: Oct. 11, 2005

(51) Int. Cl. H02M 3/18

(52) U.S. Cl. 363/59

(57) ABSTRACT

A system includes a charge pump configured to provide a boosted voltage, a voltage source configured to provide a voltage less than the boosted voltage, and a load. The system includes a coupling capacitance coupled to the load, a first switch coupled between the charge pump and the load, and a second switch coupled between the voltage source and the load.

### BACKGROUND

Some digital circuits use a charge pump to operate. A charge pump is a power supply that uses capacitors to store and transfer energy to the output, often stepping the voltage up or down. Charge is transferred from one capacitor to another under control of regulator and switching circuitry. One type of circuit that may use a charge pump to operate is a memory circuit, such as a Random Access Memory (RAM), Dynamic Random Access Memory (DRAM), Synchronous Dynamic Random Access Memory (SDRAM), or Double Data Rate-Synchronous Dynamic Random Access Memory (DDR-SDRAM).

DRAMs typically exhibit a number of leakage currents, such as subthreshold current, junction leakage, Gate-Induced Drain Leakage (GIDL), gate oxide leakage, etc. To reduce these leakage currents, low-power DRAMs typically lower internal boosted voltages (i.e., voltages higher than the external supply voltage) for inactive circuits. A boosted voltage is typically provided by a charge pump that inherently has a low current efficiency. For example, a typical single stage charge pump has an efficiency of less than 50%. To activate previously inactive circuits, the voltage for the previously inactive circuits is raised back up to the boosted voltage. If the charge pump is used to raise the voltage of the previously inactive circuits back up to the boosted voltage, more current has to be supplied to the system than is actually needed for the load.

### SUMMARY

One embodiment of the present invention provides a system. The system includes a charge pump configured to provide a boosted voltage, a voltage source configured to provide a voltage less than the boosted voltage, and a load. The system includes a coupling capacitance coupled to the load, a first switch coupled between the charge pump and the load, and a second switch coupled between the voltage source and the load.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram illustrating one embodiment of an electronic device.

FIG. 2 is a diagram illustrating one embodiment of a capacitive coupling assisted voltage switch coupled to a load.

FIG. 3 is a flow diagram illustrating one embodiment of a method for switching the capacitive coupling assisted voltage switch from a standby or self-refresh mode to an active mode.

FIG. 4 is a flow diagram illustrating one embodiment of a method for switching the capacitive coupling assisted voltage switch from an active mode to a standby or self-refresh mode.

### DETAILED DESCRIPTION

FIG. 1 is a block diagram illustrating one embodiment of an electronic system 100. Electronic system 100 includes a host 102 and a memory circuit 106. Host 102 is electrically coupled to memory circuit 106 through memory communications path 104. Host 102 is any suitable electronic host, such as a computer system including a microprocessor or a microcontroller. Memory circuit 106 is any suitable memory, such as a memory that utilizes a capacitive coupling assisted voltage switch to switch voltages applied to memory circuits. In one embodiment, memory circuit 106 comprises a Random Access Memory (RAM), such as a Dynamic Random Access Memory (DRAM), Synchronous Dynamic Random Access Memory (SDRAM), or Double Data Rate-Synchronous Dynamic Random Access Memory (DDR-SDRAM).

Memory circuit 106 includes a capacitive coupling assisted voltage switch 108. Capacitive coupling assisted voltage switch 108 receives a control (CONTROL) signal on CONTROL signal path 110 and provides a voltage signal (V_LOAD) to a load of memory circuit 106 through V_LOAD signal path 112. In one embodiment, capacitive coupling assisted voltage switch 108 receives the CONTROL signal on CONTROL signal path 110 from host 102 through memory communications path 104. In other embodiments, capacitive coupling assisted voltage switch 108 receives the CONTROL signal on CONTROL signal path 110 from any suitable device, such as a dedicated circuit that is located inside or outside memory circuit 106.

Capacitive coupling assisted voltage switch 108 provides the V_LOAD signal on V_LOAD signal path 112 based on the CONTROL signal on CONTROL signal path 110. The V_LOAD signal is a boosted voltage if the circuits of memory circuit 106 supplied by the V_LOAD signal are in an active mode. The V_LOAD signal is a voltage less than the boosted voltage if the circuits of memory circuit 106 supplied by the V_LOAD signal are in an inactive mode, such as a standby or self-refresh mode.

The CONTROL signal on CONTROL signal path 110 is provided to switch the V_LOAD signal output from capacitive coupling assisted voltage switch 108 between the lower voltage and the boosted voltage. In response to the CONTROL signal, a coupling capacitor is charged to raise the V_LOAD signal to the boosted voltage before a charge pump supplies power to the load. Therefore, no current from the charge pump is used to switch the V_LOAD signal from the lower voltage to the boosted voltage. The coupling capacitor has a current efficiency of nearly 100% such that current is saved during the switching process from the lower voltage to the boosted voltage.

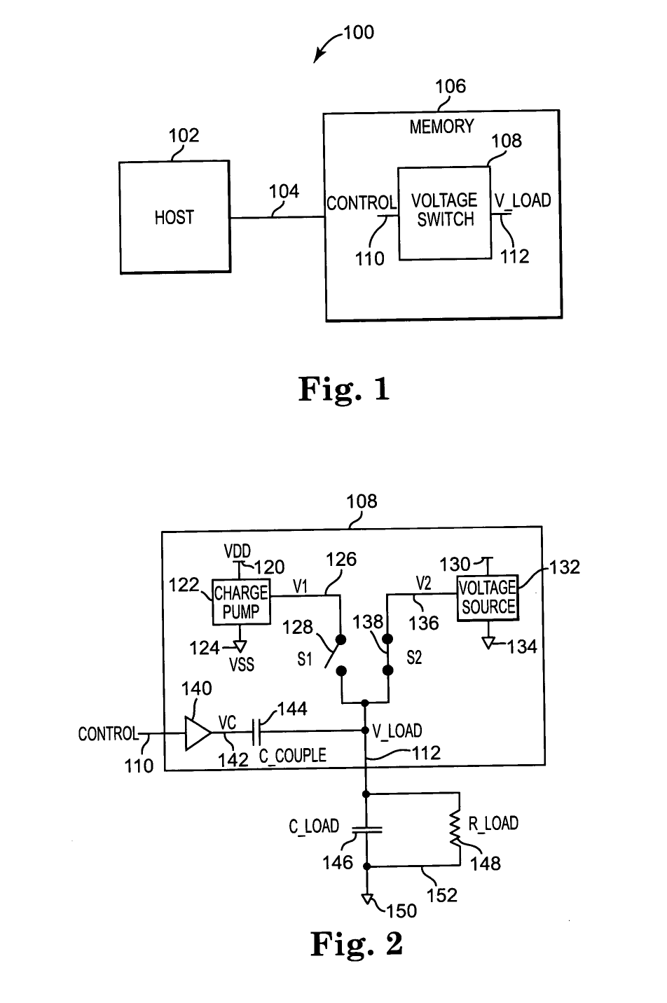

FIG. 2 is a diagram illustrating one embodiment of capacitive coupling assisted voltage switch 108 coupled to a load. Capacitive coupling assisted voltage switch 108 includes charge pump 122, voltage source 132, switches S1 128 and S2 138, buffer 140, and coupling capacitor (C_COUPLE) 144. The load includes a capacitive load (C_LOAD) 146 and a resistive load (R_LOAD 148). C_LOAD 146 represents the load capacitance of a circuit of memory circuit 106 and R_LOAD 148 represents the resistance of the circuit of memory circuit 106. An operation current, which can be leakage current only in some embodiments, passes though R_LOAD 148 during an active mode. A leakage current passes through R_LOAD 148 during a standby or self-refresh mode.

Charge pump 122 receives a first voltage (VDD) 120 and a second voltage (VSS) 124, which is less than first voltage 120. In one embodiment, VSS 124 equals zero volts. The output of charge pump 122 is electrically coupled to one side of switch S1 128 through V1 signal path 126. Voltage source 132 receives a third voltage 130 and a fourth voltage 134, which is less than third voltage 130. In one embodiment, third voltage 130 is VDD 120 and fourth voltage 134 is VSS 124. Voltage source 132 comprises a power supply VDD, voltage generator, charge pump, or other suitable voltage source. The output of voltage source 132 is electrically coupled to one side of switch S2 138 through V2 signal path 136.

The other side of switch S1 128 and the other side of switch S2 138 are electrically coupled to one side of C_COUPLE 144, one side of C_LOAD 146, and one side of R_LOAD 148 through V_LOAD signal path 112. The input of buffer 140 receives a CONTROL signal on CONTROL signal path 110. The output of buffer 140 is electrically coupled to the other side of C_COUPLE 144 through VC signal path 142. The other side of C_LOAD 146 is electrically coupled to the other side of R_LOAD 148 and common or ground 150 through signal path 152.

Charge pump 122 provides a boosted voltage V1 on V1 signal path 126. Boosted voltage V1 is greater than VDD. Boosted voltage V1 is provided to C_LOAD 146 and R_LOAD 148 during an active mode. Voltage source 132 provides voltage V2 on V2 signal path 136. Voltage V2 is less than boosted voltage V1. Voltage V2 is provided to C_LOAD 146 and R_LOAD 148 during a standby or self-refresh mode.

Switch S1 128 and switch S2 138 are voltage switches. With switch S1 128 open, boosted voltage V1 on V1 signal path 126 is blocked from passing to V_LOAD signal path 112. With switch S1 128 closed, boosted voltage V1 on V1 signal path 126 is passed to V_LOAD signal path 112. With switch S2 138 open, voltage V2 on V2 signal path 136 is blocked from passing to V_LOAD signal path 112. With switch S2 138 closed, voltage V2 on V2 signal path 136 is passed to V_LOAD signal path 112. Switch S1 128 and switch S2 138 are controlled by host 102 or a control circuit within memory circuit 106. Switch S1 128 is closed and switch S2 138 is open during an active mode. Switch S1 128 is open and switch S2 138 is closed during a standby or self-refresh mode.

Buffer 140 receives the CONTROL signal on CONTROL signal path 110 to provide the VC signal on VC signal path 142. The CONTROL signal is logic high for an active mode and logic low for a standby or self-refresh mode. In response to a logic high CONTROL signal, buffer 140 provides a VC voltage signal to charge C_COUPLE 144 up to the boosted voltage V1. C_COUPLE 144 is a charge coupling capacitance that raises the V_LOAD signal on V_LOAD signal path 112 up to the boosted voltage V1. In response to a logic low CONTROL signal, buffer 140 does not provide the VC voltage signal and C_COUPLE 144 discharges.

Voltage switching without C_COUPLE 144 would proceed as follows. During an active mode, switch S1 128 is closed and switch S2 138 is opened. V_LOAD equals the boosted voltage V1. During standby or self-refresh mode, switch S1 128 is open, switch S2 138 is closed, and V_LOAD equals the lower voltage V2. Without C_COUPLE 144, the charge Q_LOAD used to change V_LOAD from the lower voltage V2 to the boosted voltage V1 is defined as follows:
Q_LOAD=(V1−V2)*C_LOAD Equation I

With charge pump 122 having an efficiency of less than 50%, the charge Q_SUPPLY supplied externally to charge pump 122 is defined as follows:
Q_SUPPLY>2*Q_LOAD Equation II

Therefore without C_COUPLE 144, more current is supplied to charge pump 122 than is actually used for the load.

Voltage switching with C_COUPLE 144 proceeds as follows. During standby mode, switch S2 138 is closed, switch S1 128 is open, V_LOAD equals the lower voltage V2, and VC is at VSS or zero volts. Switching to boosted voltage V1 from the lower voltage V2 proceeds by opening switch S2 138, raising VC to a high level (VC_high) (e.g., VDD), and then closing switch S1 128. C_COUPLE 144 is selected such that the coupling charge Q_COUPLE equals Q_LOAD. Therefore, C_COUPLE is defined as follows:
C_COUPLE=C_LOAD*(V1−V2)/(VC_high−(V1−V2)) Equation III

Since Q_COUPLE equals Q_LOAD, no current is used from charge pump 122 during switching from the lower voltage V2 to the boosted voltage V1. Since buffer 140 and C_COUPLE 144 have a current efficiency of nearly 100%, a charge of about Q_LOAD is saved during the switching process from the lower voltage V2 to the boosted voltage V1. For switching from the boosted voltage V1 to the lower voltage V2, the sequence is reversed. No current, however, is typically saved in this direction because the lower voltage V2 is typically the power supply or a voltage generator derived voltage.

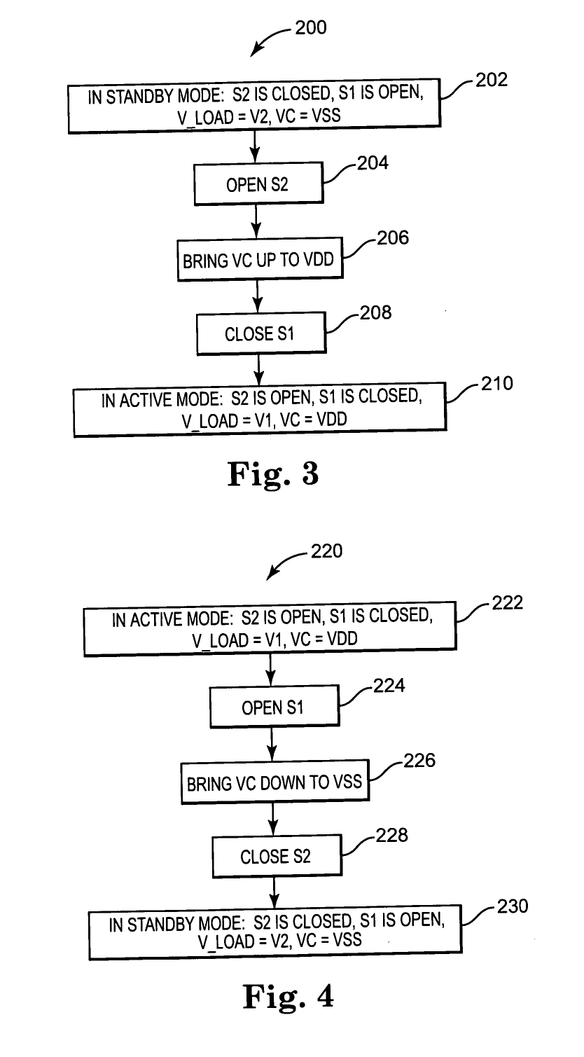

FIG. 3 is a flow diagram 200 illustrating one embodiment of a method for switching capacitive coupling assisted voltage switch 108 from a standby or self-refresh mode to an active mode. At 202, in standby mode, switch S2 138 is closed, switch S1 128 is open, V_LOAD equals the lower voltage V2, and VC equals VSS. At 204, switch S2 138 is opened. At 206, the CONTROL signal is logic high to drive buffer 140 to provide VC to charge C_COUPLE 144 up to VDD. At 208, switch S1 128 is closed. At 210, in active mode, switch S2 138 is open, switch S1 128 is closed, V_LOAD equals the boosted voltage V1, and VC equals VDD.

FIG. 4 is a flow diagram 220 illustrating one embodiment of a method for switching capacitive coupling assisted voltage switch 108 from an active mode to a standby or self-refresh mode. At 222, in active mode, switch S2 138 is open, switch S1 128 is closed, V_LOAD equals the boosted voltage V1, and VC equals VDD. At 224, switch S1 128 is opened. At 226, the CONTROL signal is logic low to discharge C_COUPLE 144 down to VSS. At 228, switch S2 138 is closed. At 230, in standby mode, switch S2 138 is closed, switch S1 128 is open, V_LOAD equals the lower voltage V2, and VC equals VSS.

Embodiments of the invention provide capacitive coupling assisted voltage switching for reducing the current used to switch a memory circuit from a lower voltage to a higher boosted voltage. By charging a coupling capacitor to raise the voltage of a load before switching to supplying the load from a charge pump, power is conserved.

What is claimed is:

1. A system comprising:
a charge pump configured to provide a boosted voltage;
a voltage source configured to provide a voltage less than the boosted voltage;
a load;
a coupling capacitance coupled to the load;
a first switch coupled between the charge pump and the load; and
a second switch coupled between the voltage source and the load.

2. The system of claim 1, wherein the coupling capacitance is configured to be charged to raise a voltage provided to the load up to the boosted voltage with the first switch open and the second switch open, and wherein the first switch is configured to be closed to pass the boosted voltage to the load once the coupling capacitance has raised the voltage provided to the load up to the boosted voltage.

3. The system of claim 1, wherein the voltage source comprises a voltage generator.

4. The system of claim 1, wherein the voltage source comprises a charge pump.

5. The system of claim 1, further comprising:
a buffer coupled to the coupling capacitor, the buffer configured to drive the coupling capacitor based on a control signal.

6. A memory comprising:
a charge pump configured to boost an internal voltage to provide a first voltage;
a power source configured to provide a second voltage less than the first voltage;
a memory circuit;
a first voltage switch configured to selectively pass the first voltage to the memory circuit;
a second voltage switch configured to selectively pass the second voltage to the memory circuit;
a charge coupling capacitor configured for switching from providing the second voltage to the memory circuit to providing the first voltage to the memory circuit without current from the charge pump; and
a buffer configured to drive the charge coupling capacitor based on a control signal.

7. The memory of claim 6, wherein the memory comprises a dynamic random access memory.

8. The memory of claim 6, wherein the power source comprises a voltage generator.

9. The memory of claim 6, wherein the power source comprises a charge pump.

10. The memory of claim 6, wherein the second voltage switch is configured to pass the second voltage to the memory circuit during a self-refresh mode.

11. A memory comprising:
a charge pump configured to provide a first voltage;
a power source configured to provide a second voltage less than the first voltage; and
means for switching from passing the second voltage to a load to passing the first voltage to the load without current from the charge pump during the switching.

12. The memory of claim 11, further comprising:
means for switching from passing the first voltage to the load to passing the second voltage to the load.

13. The memory of claim 12, wherein the means for switching from passing the first voltage to the load to passing the second voltage to the load comprises means for switching from passing the first voltage to the load to passing the second voltage to the load during an active mode.

14. The memory of claim 11, wherein the means for switching from passing the second voltage to the load to passing the first voltage to the load comprises means for switching from passing the second voltage to the load to passing the first voltage to the load during a self-refresh mode.

15. The memory of claim 11, wherein the load comprises a capacitance and a resistance.

16. A method for switching from a self-refresh mode to an active mode in a memory, the method comprising:
providing a first switch closed to pass a first voltage to a load with a memory in a self-refresh mode;
providing a second switch open to block a second voltage from passing from a charge pump to the load with the memory in the self-refresh mode;
opening the first switch to block the first voltage from passing to the load upon exiting the self-refresh mode;
charging a coupling capacitor coupled to the load up to the second voltage; and
closing the second switch to pass the second voltage from the charge pump to the load.

17. The method of claim 16, wherein providing the second switch open to block the second voltage comprises providing the second switch open to block a second voltage greater than the first voltage.

18. The memory of claim 16, wherein providing the first switch closed to provide the first voltage comprises providing the first switch closed to provide a first voltage output from a voltage generator.

19. The memory of claim 16, wherein providing the first switch closed to provide the first voltage comprises providing the first switch closed to provide a first voltage output from a charge pump.

20. The memory of claim 16, wherein charging the coupling capacitor up to the second voltage comprises charging the coupling capacitor through a buffer up to the second voltage in response to a control signal.

21. A method for operating a memory, the method comprising:
powering a memory circuit through a first switch from a first power source during a self-refresh mode;
opening the first switch upon exit of the self-refresh mode;
charging a coupling capacitor coupled to the memory circuit to a second voltage; and
powering the memory circuit through a second switch from a charge pump during an active mode.

22. The method of claim 21, wherein charging the coupling capacitor comprises charging the coupling capacitor to the second voltage to raise the voltage provided to the memory circuit to a voltage provided by the charge pump.

23. The memory of claim 21, wherein powering the memory circuit through the first switch comprises powering the memory circuit through the first switch from a voltage generator.

24. The memory of claim 21, wherein powering the memory circuit through the first switch comprises powering the memory circuit through the first switch from a charge pump.

25. The memory of claim 21, wherein charging the coupling capacitor coupled to the memory circuit to the second voltage comprises charging the coupling capacitor coupled to the memory circuit to a second voltage greater than the first voltage.
